(19) United States
(12) Patent Application Publication
(10) Pub. No.: US 2014/0099161 A1
(43) Pub. Date: Apr. 10, 2014

(54) RETAINING DEVICE

(71) Applicant: Chin-Hui CHEN, TaoYuan Hsien (TW)

(72) Inventor: Chin-Hui CHEN, TaoYuan Hsien (TW)

(21) Appl. No.: 13/726,788

(22) Filed: Dec. 26, 2012

(30) Foreign Application Priority Data
Oct. 8, 2012 (TW) 101219420

(51) Int. Cl. F16B 5/06

(52) U.S. Cl. CPC F16B 5/0607
USPC 403/326

(57) ABSTRACT

A retaining device includes a support including an uneven base; and at least one flexible latch each including a curved lower portion joining the base, an upward extending intermediate portion, and a curved transverse top. A joining edge of the upward extending intermediate portion of each of the at least one latch and the curved transverse top thereof is offset laterally with respect to a joining edge of the curved lower portion of each of the at least one latch and the base. Expansion and contraction of materials of components to be retained by the retaining device are considered in its design phase.

### BACKGROUND OF THE INVENTION

1. Field of the Invention

The invention relates to retaining devices and more particularly to a retaining device with expansion and contraction of materials of components (e.g., slats of a pallet) to be retained being considered in its design phase.

2. Description of Related Art

Expansion and contraction of materials must be considered when designing large structures or in other engineering applications when large changes in dimension due to temperature are expected. Thermal expansion is also used in mechanical applications to fit parts over one another.

A conventional retaining device A is shown in FIG. 1 and has a T-shaped longitudinal section. The retaining device comprises two side cavities A1 and two projecting sides A2 on top.

A conventional pallet is shown in FIG. 2 and comprises a plurality of parallel, spaced apart stringers B. Four retaining devices A each is provided on a top of the stringer B. A plurality of rectangular slats C each has a groove C1 on either side. Both projecting sides A2 of the retaining device A are fitted into the grooves C1 of two adjacent slats C respectively with the longitudinal part of the retaining device A clamped by the sides of the two adjacent slats C. Thus, a gap is formed between tops of the two adjacent slats C.

However, expansion and contraction of materials of the slats C are not considered in the design phase. Thus, the type of pallet is liable to malfunction (e.g., warp, breakage, etc.) due to non-fully engagement of the retaining devices A with the slats C. Thus, the need for improvement still exists.

### SUMMARY OF THE INVENTION

It is therefore one object of the invention to provide a retaining device with expansion and contraction of materials of components (e.g., slats of a pallet) to be retained being considered in its design phase.

For achieving above and other objects, the invention provides a retaining device comprising a support including an uneven base; and at least one flexible latch each including a curved lower portion joining the base, an upward extending intermediate portion, and a curved transverse top; wherein a joining edge of the upward extending intermediate portion of each of the at least one latch and the curved transverse top thereof is offset laterally with respect to a joining edge of the curved lower portion of each of the at least one latch and the base.

In a first aspect of the invention, the base comprises a positioning member.

In a second aspect of the invention, the at least one latch comprises first and second latches each having a curved lower portion substantially joined to the base, and wherein the curved transverse top of the first latch is spaced from the curved transverse top of the second latch by a predetermined distance.

In a third aspect of the invention, the curved transverse top and the upward extending intermediate portion of each of the at least one latch are adapted to urge against an object.

In a fourth aspect of the invention, each of the at least one latch is formed of aluminum alloy or elastomeric material.

In a fifth aspect of the invention, the support and each of the at least one latch are formed by extrusion.

In a sixth aspect of the invention, the first and second latches are opposite and are mirror images each other.

The above and other objects, features and advantages of the invention will become apparent from the following detailed description taken with the accompanying drawings.

### BRIEF DESCRIPTION OF THE DRAWINGS

FIG. 1 is a perspective view of a conventional retaining device;

FIG. 2 is a perspective view of a conventional pallet incorporating the retaining devices of FIG. 1 prior to final assembly;

FIG. 3 is a perspective view of a conventional retaining device according to a first preferred embodiment of the invention;

FIG. 4 is a front view of the retaining device of FIG. 3;

FIG. 5 is a perspective view showing two slats of a pallet to be retained by the retaining device of FIG. 3;

FIG. 6 is a front view of the assembled slats and the retaining device of FIG. 3;

FIG. 7 is a view similar to FIG. 6 showing a gap between the two adjacent slats decreased due to thermal expansion of the materials of the adjacent slats; and

FIG. 8 is a perspective view of a conventional retaining device according to a second preferred embodiment of the invention.

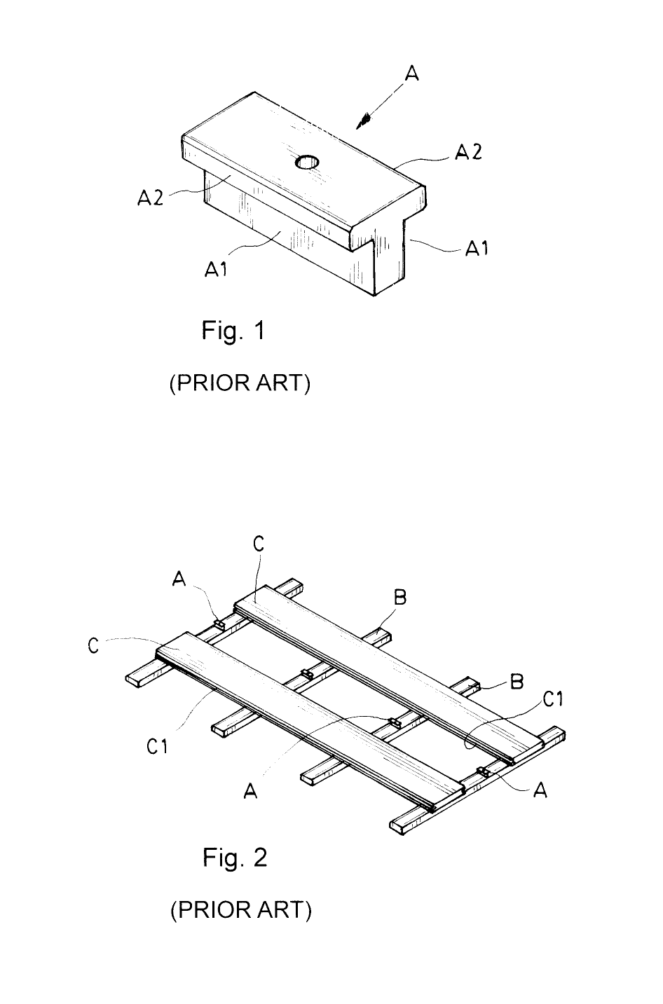

### DETAILED DESCRIPTION OF THE INVENTION

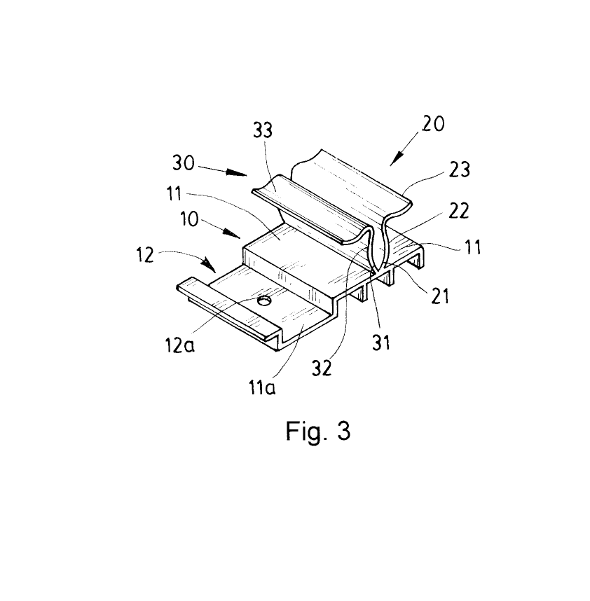

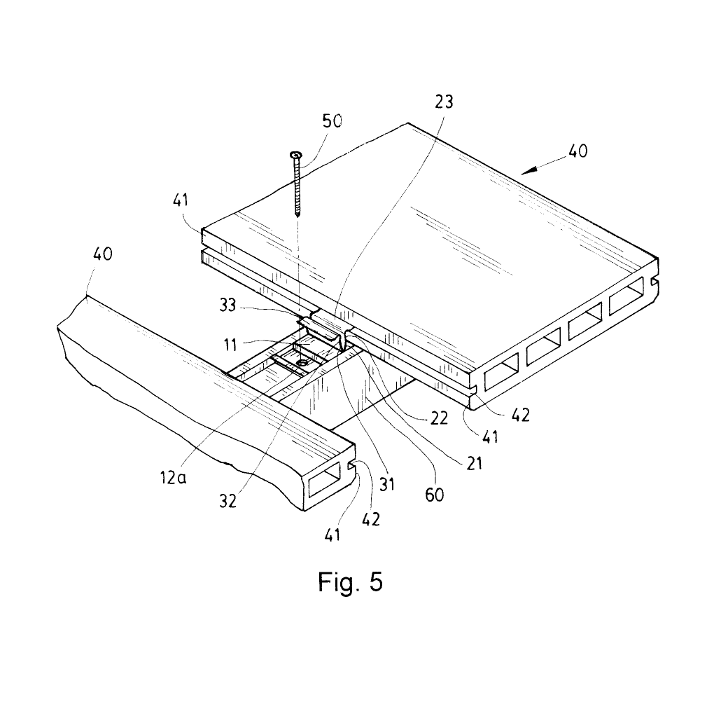

Referring to FIGS. 3 to 7, a retaining device in accordance with a first preferred embodiment of the invention is formed by extrusion and comprises a support 10, a flexible first latch 20 formed of aluminum alloy or elastomeric material, and a flexible second latch 30 formed of aluminum alloy or elastomeric material as discussed in detail below.

The support 10 is an uneven member with ribs in order to increase its structural strength. The support 10 comprises a base 11 and a positioning member 12 on the base 11. A concave portion 11a is formed on the positioning member 12. A through hole 12a is formed through the bottom of the positioning member 12. A fastener (e.g., screw) 50 can be driven through the through hole 12a into a stringer 60 of a pallet for fastening the retaining device and the pallet together.

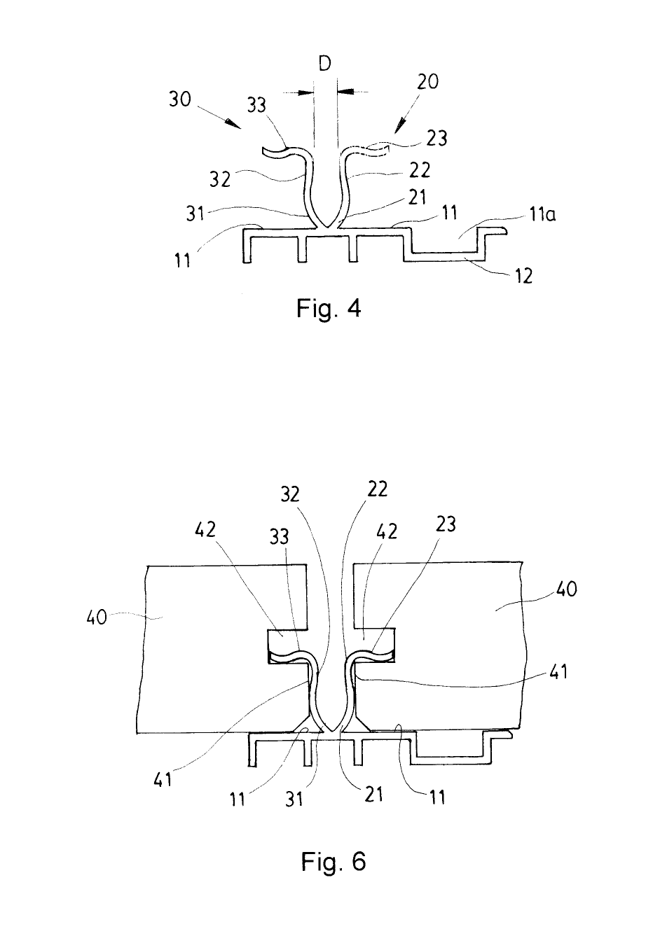

The first latch 20 has a curved longitudinal section (see FIG. 4). The first latch 20 is spaced from the positioning member 12, i.e., the positioning member 12 proximate to one side of the support 10 and the first latch 20 proximate to the other side of the support 10. The first latch 20 extends upward and comprises a curved lower portion 21, an upward extending intermediate portion 22, and a curved transverse top 23.

The second latch 30 is opposite to the first latch 20 and disposed further to the other side of the support 10. The second latch 30 is spaced from the first latch 20. The second latch 30 is a mirror image of the first latch 20 and has a curved longitudinal section (see FIG. 4). The second latch 30 extends upward and comprises a curved lower portion 31 substantially joined to the curved lower portion 21 of the first latch 20, an upward extending intermediate portion 33, and a curved transverse top 33 spaced from the curved transverse top 23 of the first latch 20 by a distance D.

A plurality of slat 40 each is hollow with internal ridges in order to increase its structural strength. The slat 40 comprises a groove 42 on either side 41. The curved transverse top 23 of the first latch 20 and the curved transverse top 33 of the second latch 30 are disposed on bottoms and urged against inner ends of the grooves 42 of two adjacent slats 40 respectively. Further, the upward extending intermediate portion 22 of the first latch 20 and the upward extending intermediate portion 32 of the second latch 30 are urged against edges of the sides 41 of the two adjacent slats 40 respectively. As a result, the slats 40 are retained by the retaining device of the invention.

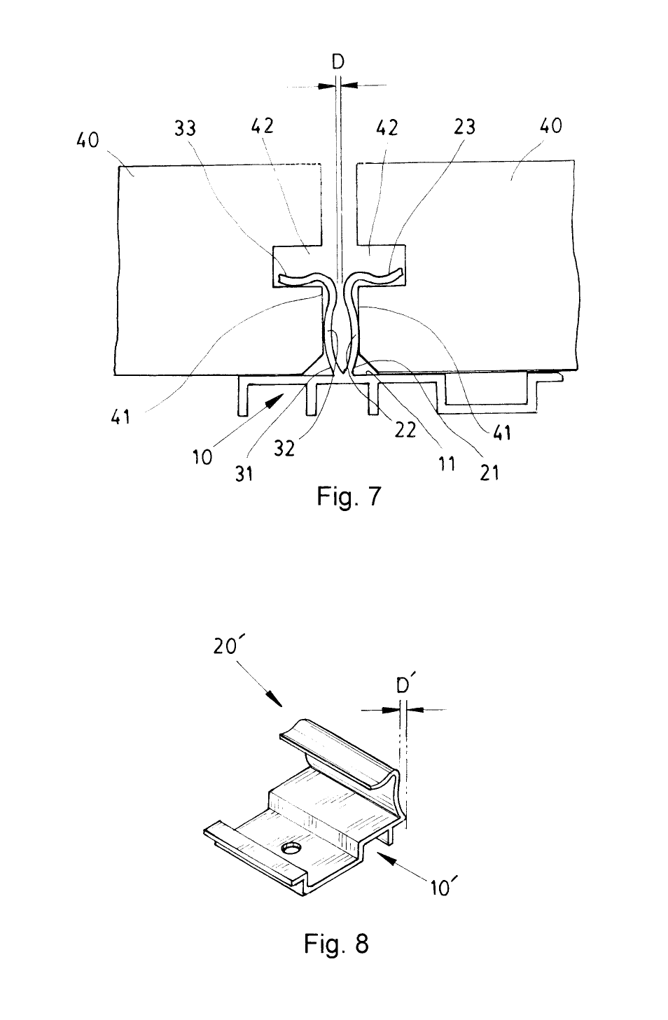

The slats 40 are formed of materials that may expand or contract greatly in dimension due to thermal expansion. Advantageously, the flexibility of the retaining device can accommodate the effect of thermal expansion. As shown in FIG. 7, in one exemplary example, the slats 40 may expand laterally due to temperature rise. The expanded slats 40 thus compress the first and second latches 20 and 30 toward each other to decrease the distance D. It is envisaged that the structural integrity of the slats 40 and thus the pallet can be maintained. It is understood that the slats 40 may return to the position of FIG. 6 when temperature drops.

Referring to FIG. 8, a retaining device in accordance with a second preferred embodiment of the invention is shown. The characteristics of the second preferred embodiment are substantially the same as that of the first preferred embodiment except the following: The retaining device comprises an uneven support 10′ and a flexible latch 20′ at one side. The joining edge of the upward extending intermediate portion of the latch 20′ and the curved transverse top of the latch 20′ is offset laterally with respect to the joining edge of the curved lower portion of the latch 20′ and one side of the support 10′ by a distance D1.

While the invention has been described in terms of preferred embodiments, those skilled in the art will recognize that the invention can be practiced with modifications within the spirit and scope of the appended claims.

What is claimed is:

1. A retaining device comprising:
a support comprising an uneven base; and
at least one flexible latch each including a curved lower portion joining the base, an upward extending intermediate portion, and a curved transverse top;
wherein a joining edge of the upward extending intermediate portion of each of the at least one latch and the curved transverse top thereof is offset laterally with respect to a joining edge of the curved lower portion of each of the at least one latch and the base.

2. The retaining device of claim 1, wherein the base comprises a positioning member.

3. The retaining device of claim 1, wherein the at least one latch comprises first and second latches each having a curved lower portion substantially joined to the base, and wherein the curved transverse top of the first latch is spaced from the curved transverse top of the second latch by a predetermined distance.

4. The retaining device of claim 1, wherein the curved transverse top and the upward extending intermediate portion of each of the at least one latch are adapted to urge against an object.

5. The retaining device of claim 1, wherein each of the at least one latch is formed of aluminum alloy or elastomeric material.

6. The retaining device of claim 1, wherein the support and each of the at least one latch are formed by extrusion.

7. The retaining device of claim 3, wherein the first and second latches are opposite and are mirror images each other.
